(19) United States
(12) Patent Application Publication
(10) Pub. No.: US 2002/0087844 A1
(43) Pub. Date: Jul. 4, 2002

(54) Apparatus and method for concealing switch latency

(76) Inventors: Udo Walterscheidt, San Jose, CA (US); Thomas E. Willis, Mountain View, CA (US)

Correspondence Address: KENYON & KENYON, Suite 600, 333 W. San Carlos Street, San Jose, CA, 95110-2711, US

(21) Appl. No.: 09/753,766

(22) Filed: Dec. 29, 2000

(51) Int. Cl. G06F 9/00

(52) U.S. Cl. 712/228

(57) ABSTRACT

An multi-threading processor is provided. The multi-threading processor includes a front end module, an execution module coupled to the front end module, and a state module coupled to both the front end module and the execution module. The processor also includes a switch logic module, which is coupled to the state module. The switch logic module detects switching events and mispredicted branches and conceals switch latency by attempting to schedule switches to other software threads during the latencies of the mispredicted branches.

### BACKGROUND OF THE INVENTION

1. Field of the Invention

The present invention relates generally to increasing utilization and overall performance in multi-threading microprocessors. More particularly, the present invention relates to maximizing the efficiency of processors by concealing the switch latency of a multi-threading microprocessor by switching the processor to a different software thread when a mispredicted branch has occurred.

2. Description of the Related Art

In a conventional computer system, microprocessors are typically required to run more than one program (which may include more than one software thread). The computer system utilizes an operating system (OS) to direct the microprocessor to run each of the programs based on priority. The simplest type of priority system simply directs the OS to run the programs in sequence (i.e., the last program to be run has the lowest priority). In other systems, the priority of a program may be assigned based on other factors, such as the importance of the program, how efficient it is to run the program, or both. Through priority, the OS is then able to determine the order in which a program or a software thread is executed.

One way of optimizing the performance of a computer system is to design it so that its microprocessor(s) are being utilized as much as possible. Unfortunately, one of the traditional constraints of a processor was that if a program or a software thread being executed was unable to continue and stalled by an event (e.g., because the event requires a long latency memory access), the processor would experience idle cycles for the duration of the stalling event, thereby decreasing the overall system performance.

Recent developments in processor design have allowed for multi-threading, where two or more distinct threads are able to make use of available processor resources. One particular form of multi-threading is Switch on Event Multi-Threading (SoEMT). In SoEMT, if one thread is stalled by an event, the processor (not the OS) may switch the execution context to a second thread. Such an event is known as a switching event. The second thread then takes control over the processor and executes its program until the program is finished or another switching event occurs, upon which the processor may switch back to execute the original thread or execute a different thread.

While the ability to switch the processor between threads can dramatically increase processor utilization, the overall performance of a SoEMT system may still be hampered by the fact that switching from one software thread to the other takes a predetermined amount of time. This switch latency includes the overhead to detect and process the thread switch as well as flushing the execution pipeline and refilling it with the new thread's instructions. When processors encounter a large number of switching events, a significant amount of processor time may be devoted to switch latency, which would diminish the performance advantage gained from switching.

One way of eliminating switch latency is to utilize a processor design known as simultaneous multi-threading (SMT), which allows multiple threads to issue instructions each cycle. Unlike SoEMT, in which only a single thread is active on a given cycle, SMT permits all threads to compete for and share processor resources at the same time. Unfortunately, SMT systems do not represent an entirely adequate method of eliminating switch latency because SMT systems are extremely expensive to manufacture. SMT systems are also very complex and require far more computing power to operate than a SoEMT system. Therefore, it is desirable to have a method and apparatus that reduces or eliminates switch latency in a multi-threading system without incurring the cost of manufacturing a SMT system.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 illustrates a SoEMT system in accordance with one embodiment of the present invention.

FIG. 2 illustrates two software threads that are monitored by a switch logic module in accordance with one embodiment of the present invention.

FIG. 3 is a flow chart of a method for reducing switch latency in a multi-threading computer system in accordance with one embodiment of the present invention.

FIG. 4 is a flow chart of a method for reducing switch latency in a multi-threading computer system in accordance with a preferred embodiment of the present invention.

### DETAILED DESCRIPTION

A method and apparatus for concealing switch latency in a multi-threading computer system is provided. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

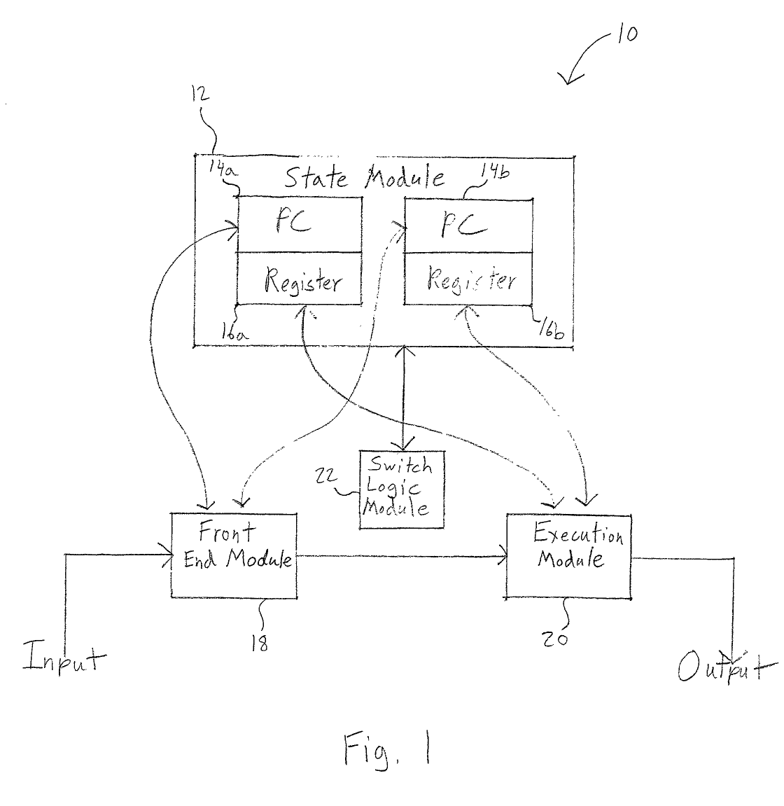

FIG. 1 illustrates a SoEMT computer system 10 in accordance with one embodiment of the present invention. SoEMT system 10 includes a state module 12 having a pair of instruction pointers (IP) 14a and 14b and a pair of register files 16a and 16b. State module 12 is coupled to a front end module 18. State module 12 is also coupled to an execution module 20. Front end module 18 is coupled to an input and execution module 20 is coupled to an output. SoEMT system 10 also includes a switch logic module 22, which is coupled to state module 12. Front end module 18 has read/write access to IPs 14a and 14b. Execution module 20 has read/write access to register files 16a and 16b and read only access to IPs 14a and 14b.

In SoEMT system 10, front end module 18 receives and decodes an input containing instructions while performing the necessary diagnostics. The instructions are eventually transmitted to state module 12 and execution module 20. At the same time, execution module 20 carries out the preceding instructions and generates an output. By decoding one instruction while the preceding instruction is executing, the microprocessor saves time. This “assembly line” is called pipelining. As is well known in the art, the pipeline may have many steps to accommodate numerous sequential instructions at the same time, one or more at each stage in the pipeline (current microprocessors can accommodate up to six instructions per stage).

SoEMT system 10 differs from single threading systems by duplicating IPs and register files within state module 12 while using only one true processor. IPs 14a-b and register files 16a-b are monitored by switch logic module 22, which determines which software threads are executed. While SoEMT system 10 is configured to handle only two threads in FIG. 1, it is understood by those skilled in the art that state module 12 may include additional IPs 14 and register files 16 to accommodate additional threads.

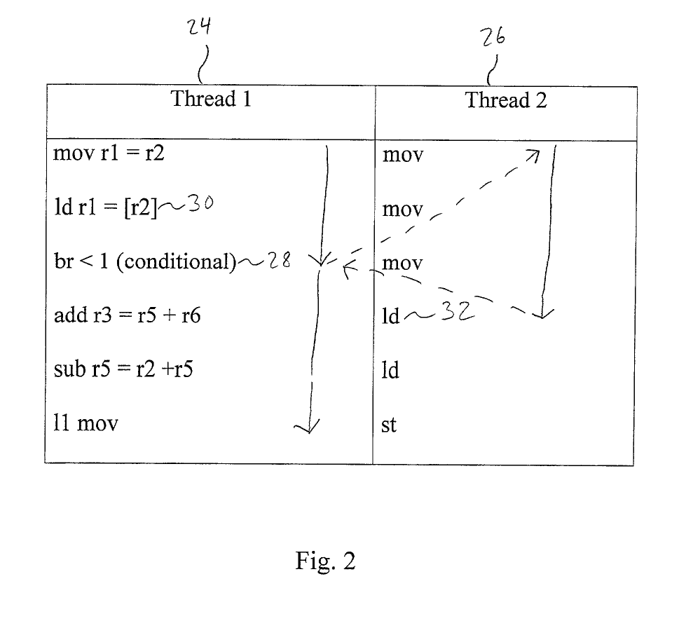

FIG. 2 illustrates two software threads 24 and 26 that are monitored by switch logic module 22 in accordance with one embodiment of the present invention. Software thread 24 also includes a mispredicted branch instruction 28. A branch instruction is a command having the if-then-else construct. Because branch instructions provide the processor with the location of the next instruction, the processor is traditionally stalled because it cannot be sure where the next instruction is located. Thus, without any other way of discovering the location of the next instruction, each branch instruction will always force a break in the flow of instructions through the pipeline. The longer the pipeline, the longer the processor must wait until it knows which instruction execute next.

To avoid this break in the flow of instructions, microprocessors attempt to predict what the branch instruction will do, based on a record of what the particular branch instruction did before. The microprocessor then decides which instruction to load next into the pipeline based on the branch prediction. This speculative execution has the potential to save lot of processor time, but only if the branch prediction is correct. If the prediction turns out to be wrong, it is termed a mispredicted branch. The processor must then “pay” an unavoidable time penalty by flushing the pipeline to discard all of the calculations that were based on the mispredicted branch.

Referring back to FIG. 2, switch logic module 22 monitors software threads 24 and 26 to detect switching events and mispredicted branches. Assuming that load commands 30 and 32 are switching events, switch logic module 22 will classify them as either switching events that can be rescheduled or as switching events that must be switched immediately. A switching event that must be switched immediately is typically an event that requires a long latency memory access and would otherwise stall the processor and result in wasted idle cycles.

Assuming that load command 30 is a switching event that can be rescheduled, switch logic module 22 will reschedule the switch from software thread 24 to software thread 26 until it detects a mispredicted branch. After mispredicted branch 28 is detected, the processor is forced to pay the mispredicted branch penalty by flushing the pipeline and discarding all the calculations based on the incorrect prediction. However, at the same time, switch logic module 22 switches the processor from executing software thread 24 to executing software thread 26.

Because the switch has been rescheduled to occur at the same time as the branch misprediction penalty, the switch latency is at least partially, if not fully concealed by the branch misprediction penalty. Normally, switch latency is unavoidable because it takes perhaps about 15 to about 20 clocks to switch the processor to a different software thread. However, because the execution penalty resulting from a branch misprediction is also unavoidable, it is advantageous to schedule switching at the same time, thereby consolidating the latencies as much as possible.

Through this process, the switch latency is effectively reduced or eliminated by the length of time it takes to flush the pipeline due to the incorrect branch prediction. Since today's processors tend to have longer and longer pipelines compared to older processors, the reduction in switch latency may be substantial especially since mispredicted branches typically occur more frequently than switching between software threads. This is particularly true in applications that have a lot of switching events that threaten to diminish the performance advantage gained by multi-threading.

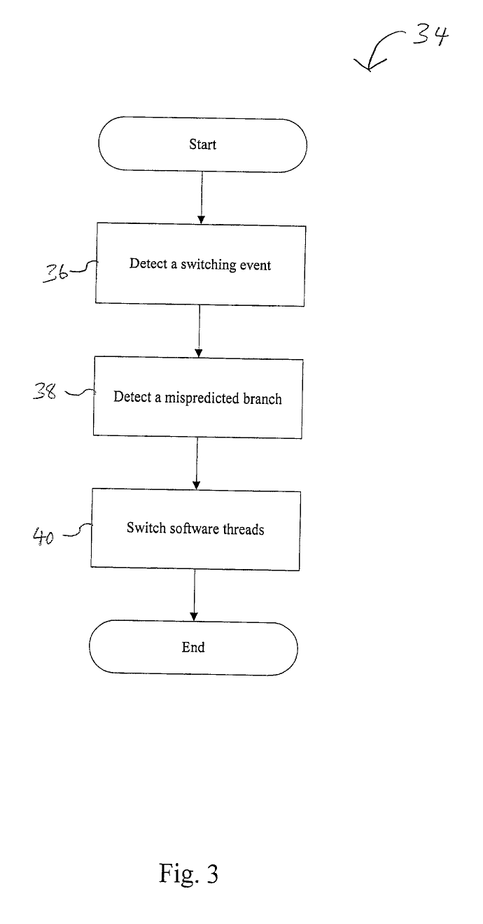

FIG. 3 is a flow chart of a method 34 for reducing switch latency in a multi-threading computer system in accordance with one embodiment of the present invention. Method 34 begins at a block 36 in which a switching event is detected by the processor. A mispredicted branch is then detected in a block 38. After both a switching event and a mispredicted branch have been detected, the processor switches to another software thread in a block 40. The switch occurs during the latency of the mispredicted branch as the processor flushes the pipeline to discard all of the calculations based on the mispredicted branch. In this manner, the multi-threading computer system consolidates the switch latency and the mispredicted branch latency. Therefore, the amount of time saved equals the switch latency minus the mispredicted branch latency.

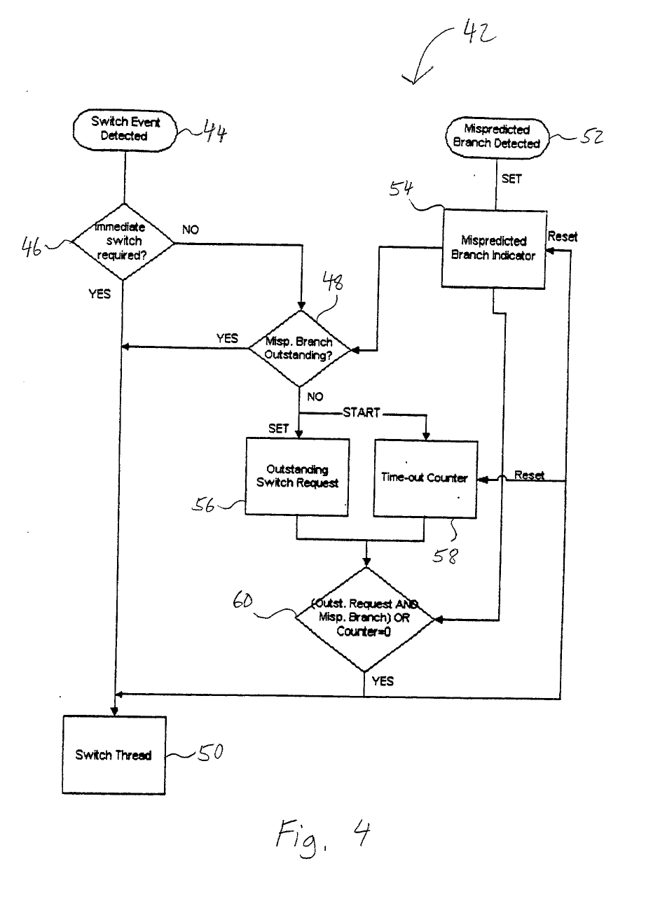

FIG. 4 is a flow chart of a method 42 for reducing switch latency in a multi-threading computer system in accordance with a preferred embodiment of the present invention. Method 42 begins at a block 44 when a switching event has been detected. If a switching event is detected, the switch logic module determines in a block 46 whether the switching event requires the processor to switch threads immediately. An example of such a switching event would be a load command requiring a long latency memory access. Loads are typically implemented as “non-blocking” loads, which will not stall the pipeline, making it possible to reschedule a switch. However, the processor will stall on the use of the loaded data by a subsequent instruction. Because the event would stall the processor and result in wasted idle cycles, an immediate switch to another software thread is necessary.

If an immediate switching event is detected, then the processor switches threads in a block 48. If an immediate switch is not required, then method 42 proceeds to a block 50, which determines whether or not a mispredicted branch is outstanding. Examples of switching events that can be rescheduled are switches necessary because of switches resulting from cache misses, and time quanta switches (which are discussed in greater detail below).

At the same time switching events are being detected in block 44, method 42 may also begin at a block 52 when a mispredicted branch is detected. After detection, a mispredicted branch indicator is set in a block 54. The indicator allows block 50 to determine whether or not a mispredicted branch is outstanding. If a switch event has been detected and a mispredicted branch is outstanding, then the switch latency can be concealed by the mispredicted branch latency, and method 42 proceeds to block 52 where the processor switches threads. If a mispredicted branch has not been detected in block 52, then the mispredicted branch indicator from block 54 has a reset value. Therefore, block 50 determines that a mispredicted branch is not outstanding and method 42 proceeds to blocks 56 and 58 at the same time.

In block 56, an outstanding switch request indicator is set because a switch event was previously detected in block 44. Then a time-out counter is started in block 58 to ensure that the switch will occur regardless of whether a mispredicted branch is detected in block 52. (Note that another time-out counter may be used to trigger a switch in the absence of any other switching event). Therefore, a block 60 determines whether the time quantum has passed or whether a switch request and a mispredicted branch are both outstanding. If either of these conditions is met, then method 42 proceeds to block 50 where the processor switches software threads. At the same time, the mispredicted branch indicator and the time-out counter are reset.

The amount of time that the time-out counter is set to is known as the time quantum. The time quantum may vary from application to application, however it is always set to an amount of time that ensures fairness between the software threads. In other words, even though method 42 is waiting for a mispredicted branch to occur in block 60 and therefore an opportunity to conceal the switch latency, after the time quantum has passed, the processor must be switched so that other threads are not ignored for too long. Typically, the time quantum is less than about 1,000 clocks and preferably about 200 clocks.

In summary, the present invention provides for a method and apparatus for concealing switch latency in a multi-threading computer system. The present invention includes a processor having a switch logic module, which detects switching events and mispredicted branches in a software thread. When a switching event is detected, the switch logic module determines whether or not an immediate switch to a different software thread is required. If an immediate switch is not required, then the switch logic module determines whether a mispredicted branch is outstanding. If a mispredicted branch is outstanding, then the processor switches software threads, concealing at least part if not all of the switch latency in the unavoidable mispredicted branch latency. If a mispredicted branch is not detected, then the switch logic module delays the switch for a certain time quantum, and then executes the switch in the interest of fairness.

Other embodiments of the invention will be apparent to those skilled in the art from consideration of the specification and practice of the invention. Furthermore, certain terminology has been used for the purposes of descriptive clarity, and not to limit the present invention. The embodiments and preferred features described above should be considered exemplary, with the invention being defined by the appended claims.

What is claimed is:

1. A multi-threading processor, comprising:
a front end module;
an execution module coupled to said front end module;
a state module coupled to said front end module and said execution module; and
a switch logic module coupled to said state module, wherein said switch logic module detects a mispredicted branch in a software thread and schedules a switch to another software thread during a latency of said mispredicted branch.

2. A multi-threading processor as recited in claim 1, wherein the switch logic module detects a switching event.

3. A multi-threading processor as recited in claim 2, wherein the switch logic module includes a mispredicted indicator that is set when a mispredicted branch is detected and reset when the switch is completed.

4. A multi-threading processor as recited in claim 3, wherein the switch logic module includes an outstanding switch request indicator that is set when the switching event does not require an immediate switch.

5. A multi-threading processor as recited in claim 4, wherein the switch logic module includes a counter to schedule a switch based on a time quantum.

6. A multi-threading processor as recited in claim 1, wherein the state module includes a pair of register files and a pair of IPs.

7. A multi-threading processor as recited in claim 6, wherein the IPs are coupled to the front end module and the register files are coupled to the execution module.

8. A method for concealing switch latency in a multi-threading processor, comprising:
detecting a switching event in a software thread;
determining whether a mispredicted branch has been detected in said software thread; and
executing a switch to another software thread during a latency of said mispredicted branch if said mispredicted branch has been detected.

9. A method for concealing switch latency in a multi-threading processor as recited in claim 8, further comprising executing a switch to another software thread if the switching event requires an immediate switch.

10. A method for concealing switch latency in a multi-threading processor as recited in claim 9, further comprising ensuring that the switch to another software thread is executed before a time quantum expires.

11. A method for concealing switch latency in a multi-threading processor as recited in claim 10, wherein the switch has a latency of about 15 to about 20 clocks.

12. A method for concealing switch latency in a multi-threading processor as recited in claim 11, wherein the time quantum is less than about 1,000 clocks.

13. A method for concealing switch latency in a multi-threading processor as recited in claim 12, wherein the time quantum is about 200 clocks.

14. A set of instructions residing in a storage medium, said set of instructions capable of being executed by a processor for searching data stored in a mass storage device comprising:
detecting a switching event in a software thread;
determining whether a mispredicted branch has been detected in said software thread; and
executing a switch to another software thread during a latency of said mispredicted branch if said mispredicted branch has been detected.

15. A method for concealing switch latency in a multi-threading processor as recited in claim 14, further comprising executing a switch to another software thread if the switching event requires an immediate switch.

16. A method for concealing switch latency in a multi-threading processor as recited in claim 15, further comprising ensuring that the switch to another software thread is executed before a time quantum expires.

17. A method for concealing switch latency in a multi-threading processor as recited in claim 16, wherein the switch has a latency of about 15 to about 20 clocks.

18. A method for concealing switch latency in a multi-threading processor as recited in claim 17, wherein the time quantum is less than about 1,000 clocks.

19. A method for concealing switch latency in a multi-threading processor as recited in claim 18, wherein the time quantum is about 200 clocks.
